(19) United States
(12) Patent Application Publication
(10) Pub. No.: US 2009/0065737 A1
(43) Pub. Date: Mar. 12, 2009

(54) POLYMERIZATION CONTROLLERS FOR COMPOSITES CURED BY ORGANIC PEROXIDE INITIATORS

(75) Inventors: Michael O. Wells, West Lawn, PA (US); Scott C. Schmidt, West Chester, PA (US)

Correspondence Address: ARKEMA INC.;PATENT DEPARTMENT - 26TH FLOOR, 2000 MARKET STREET, PHILADELPHIA, PA, 19103-3222, US

(73) Assignee: Arkema Inc., Philadelphia, PA (US)

(21) Appl. No.: 11/853,349

(22) Filed: Sep. 11, 2007

(51) Int. Cl. C08F 2/38; C09K 3/00

(52) U.S. Cl. 252/182.14; 252/182.23; 525/340; 525/386; 525/387

(57) ABSTRACT

The use of nitroxides to control free radical cured resin systems used in the production of thermosetting materials such as bulk molded compositions, sheet molded compositions, and pultrusions is disclosed. The invention could also be employed in other resin systems where control of kinetics would be desirable such as in adhesive formulations, in solid surface composites, and certain types of polyester casting resins.

### FIELD OF THE INVENTION

The present invention relates to the control of curing thermosetting resin compositions with radical initiators. More particularly, the present invention relates to the use of nitroxides to control free radical cured systems used in the production of thermosetting materials such as bulk molded compositions, sheet molded compositions, and pultrusions. Other potential resin systems that could benefit from the control of kinetics would include adhesive formulations, solid surface composites, and certain types of polyester casting resins.

### DESCRIPTION OF RELATED ART

Premature curing during the preparatory phase is a major difficulty in the use of free radical compounds in curing of thermosetting materials. By free radical compounds or radical initiators we include molecules that can produce radical species under mild conditions and promote radical polymerization reactions. Peroxides are the preferred free radical compounds. The preparatory phase generally consists of blending the constituents and forming them. The operating conditions of this preparatory phase quite often lead to decomposition of the peroxide initiator, thus inducing the curing reaction with the formation of gel particles in the bulk of the blend. The presence of these gel particles leads to imperfections (inhomogeneity or surface roughness) of the final product. The preparatory phase curing reaction can also lead to accelerated polymerization producing unusable resin mixes or incomplete mold fill prior to set leading to scrap parts.

Several solutions have been proposed to overcome this drawback. It has been proposed to use an initiator with a longer half-life at high temperature. The drawbacks of this approach are the low production efficiency due to a long curing time and the high energy costs. Traditionally, anti-oxidants have been used as preparatory phase stabilizers. These materials include butylated hydroxytoluene (BHT), hydroquinones and derivatives, and catechols. These materials all work by capturing the free radicals generated from peroxide decomposition, and converting them into a stable and unreactive form. The penalty from using too much of these materials is that over time, radicals produced are lost from the system by absorption into the “radical scavengers” also called inhibitors. This irreversible inhibition reduces the number of radicals available for cure.

It has also been proposed to incorporate certain additives in order to reduce the polymerization tendency. Thus, the use of a mixture of two different inhibitors, one of which is 2,2,6,6-tetramethyl 1-1-piperidinyloxy (TEMPO) as inhibitors for free radical polymerizations of unsaturated monomer was described in U.S. Pat. No. 6,660,181. The use of TEMPO to stabilize ethylenically unsaturated monomer or oligomer compositions from premature polymerization is disclosed in U.S. Pat. No. 5,290,888. The primary drawback to TEMPO and TEMPO derivatives are the high temperature of equilibrium. The use of TEMPO in full styrenic resins is limited due to the high reaction temperatures needed to overcome the equilibrium temperature of the TEMPO-styrene adduct.

However, the prior use of additives are directed at inhibiting the curing of unsaturated composite resins and not at controlling the temperature and speed of curing unsaturated composite resins without impact on the final heat induced curing.

### SUMMARY OF THE INVENTION

The present invention makes it possible to control the crosslinking of thermosetting resins without having a negative impact on the crosslinking time or temperature. This is achieved by using unique nitroxides in combination with a free radical based curing system. These nitroxides have also have favorable temperature equilibriums with other reactive components of thermosetting resin systems including acrylics, acrylamides, dienes, vinylics and mixtures thereof.

One aim of the present invention is to provide a thermoset resin polymerization control composition comprising at least one nitroxide and at least one free radical source. The free radical source preferentially being a peroxide. The nitroxide is preferably used in weight proportions ranging from 1:0.001 to 1:0.5 and advantageously between 1:0.01 and 1:0.25:peroxide:nitroxide.

The present invention also provides a crosslinkable composition (B) comprising a thermosetting resin that may be crosslinked by means of a free-radical initiator system comprising a combination of organic peroxides and nitroxides. The free-radical initiator system preferably represents between 0.2 and 5 parts and advantageously between 0.5 and 3 parts per 100 parts by weight of polymer.

In the manufacture of unsaturated polyester and vinyl ester resins, a small amount of a traditional antioxidant inhibitor is added to prevent premature polymerization and improve the resins shelf-life. However, these must be used sparingly as inhibitors have the tendency to slow down the reactivity of the resin once the user wants it to cure. An added benefit to the use of the nitroxide within the polyester resin is that it will impart an additional level of storage stability without affecting the reactivity of the resin during cure.

The present invention also provides molded or pultruded articles such as bulk molded compositions, sheet molded compositions, cured in place pipe, and pultrusions made with a crosslinking combination comprising peroxides and nitroxides.

### DETAILED DESCRIPTION OF PREFERRED EMBODIMENTS

The primary resins used in composites, such as bulk molded or sheet molded compositions are polyester and vinyl ester. These resins are used in over 95% of the total composites production worldwide.

Unsaturated polyester resins are the most widely used resin systems, particularly in the marine industry. Unsaturated polyester resin is a thermoset, capable of being cured from a liquid or solid state when subject to the right conditions. It is usual to refer to unsaturated polyester resins as ‘polyester resins’, or simply as ‘polyesters’. There is a whole range of polyesters made from different acids, glycols and monomers, all having varying properties as will be evident to those skilled in the art. Several general classes are described below, but not meant to be limiting.

Most polyester resins are viscous, pale colored liquids consisting of a solution of a polyester in a reactive diluent such as monomer, usually styrene. The addition of styrene in amounts of up to 50% helps to make the resin easier to handle by reducing its viscosity. The styrene also performs the vital function of enabling the resin to cure from a liquid to a solid by ‘crosslinking’ the molecular chains of the polyester without the evolution of any by-products. These resins can therefore be molded without the use of pressure and are called ‘contact’ or ‘low pressure’ resins. Polyester resins have a limited storage life as they will set or ‘gel’ on their own over a long period of time. Often small quantities of inhibitor are added during the resin manufacture to slow this gelling action.

An example of the polyesters used in the present invention are unsaturated polyesters in which one of the structural units (also referred to a building block) is a long chain polyol having the structural formula:

H—[—CHR—(CH₂)ₓ—O—]_{y}—H

in which R is hydrogen or methyl, x is an integer from 1-4, and y is an integer from 2-50. One or more of these polyols can be used. A preferred polyol is poly(1,2-propylene glycol) having a molecular weight of about 400 to about 2900, preferably about 600 to about 800. A copolymer of two or more of these polyols can also be used.

The unsaturated polyesters (sometimes referred to as polyester alkyds) useful in the present invention are a class of soluble, linear, low molecular weight (from about 5,000 to about 15,000) materials which contain both carboxylic ester groups and carbon-carbon double bonds as recurring units along the main polymer chain. These polyesters may be prepared by condensation of long chain polyols (as described above), diols, ethylenically unsaturated dicarboxylic acids or anhydrides (to impart the unsaturation) and saturated dicarboxylic acids (to modify the polymer). The use of a long chain polyol imparts flexibility to the polyester.

Vinyl Ester resins are similar in their molecular structure to polyesters, but differ primarily in the location of their reactive sites, these being positioned only at the ends of the molecular chains. As the whole length of the molecular chain is available to absorb shock loadings this makes vinyl ester resins tougher and more resilient than polyesters. The vinyl ester molecule also features fewer ester groups. These ester groups are susceptible to water degradation by hydrolysis which means that vinyl esters exhibit better resistance to water and many other chemicals than their polyester counterparts, and are frequently found in applications such as pipelines and chemical storage tanks.

The compounds which may be used as free-radical initiators for the composites include compounds such as organic peroxides, which, upon thermal decomposition, produce free radicals which facilitate the curing/crosslinking reaction. Among the free-radical initiators used as crosslinking agents, diacyl peroxides, peroxydicarbonate, and peroxyester initiators are preferred. A detailed description of these compounds is found in Encyclopedia of Chemical Technology, 3rd edition, vol. 17, pages 27 to 90 (1982).

Specific examples of peroxydicarbonates include diethyl peroxydicarbonate, di-n-butyl peroxydicarbonate, diisobutyl peroxydicarbonate, and di-4-tert-butylcyclohexyl peroxydicarbonate. Preferably the peroxydicarbonate is di-sec-butyl peroxydicarbonate, di-2-ethylhexyl peroxydicarbonate, di-n-propyl peroxydicarbonate or diisopropyl peroxydicarbonate.

Specific examples of diacyl peroxides include benzoyl peroxide, dilauroyl peroxide, didecanoyl peroxide, diacetyl peroxide, and di(3,5,5-trimethylhexanoyl) peroxide. Specific examples of peroxyesters include t-butyl perneodecanoate, t-butyl and t-amyl peroxy 2-ethylhexanoate, and t-butyl perbenzoate. In addition the monoperoxycarbonates based on t-butyl and t-amyl monoperoxy 2-ethylhexyl carbonates are applicable to this embodiment.

The peroxide compound may be symmetrical or unsymmetrical. The peroxide may be a homogeneous mixture containing symmetric peroxides, asymmetric peroxides such as isopropyl-sec-butyl peroxydicarbonate or 2-methylpropionyl-3-methylpentanoyl peroxide or a mixture of symmetric and asymmetric peroxides such as mixtures of diisopropyl peroxydicarbonate, di-sec-butyl peroxydicarbonate and isopropyl-sec-butyl peroxydicarbonate.

The peroxydicarbonate compounds and diacyl peroxide compounds can be synthesized by conventional techniques familiar to one of ordinary skill in the art. Peroxydicarbonates are typically prepared by reacting the corresponding alkyl chloroformate with aqueous sodium peroxide at low temperatures, 0°-20° C. See U.S. Pat. No. 2,370,588. Diacyl peroxides are typically made from acid chlorides using synthetic techniques familiar to one of ordinary skill in the art.

Preferably, the peroxydicarbonates and diacyl peroxides with which this invention is useful include those which are a liquid at 0° C. and more preferably a liquid at −5° C. Still more preferred are the peroxydicarbonates and diacyl peroxides which are liquid down to −20° C. Solid peroxydicarbonates and diacyl peroxides can also be used.

The present invention is especially applicable to aqueous dispersions of peroxydicarbonates and diacyl peroxides that are useflul as initiators in the free radical polymerization of ethylenically unsaturated materials in bulk.

The initiation of the crosslinking of the composite materials by the peroxide occurs by standard mechanisms. The nitroxides modify the reactivity of the propagating polymer chains by acting to ‘cap’ the propagating radical at a temperature below the temperature of equilibrium defined by the nitroxide-monomer pair. Above the equilibrium temperature of the nitroxide-monomer pair, the nitroxide dissociates and the propagating radical becomes active again in polymer chain propagation. The net effect of this is that at ambient temperatures, the nitroxide stops polymer chain propagation and in effect acts to inhibit the reaction. In contrast to a true inhibitor, the nitroxide only caps the radical, as the active radical forms again upon heating. Once the dissociation temperature of the nitroxide monomer pair has been reached, the polymer chain begins to propagate in a controlled fashion governed by the equilibrium kinetics of the nitroxide. This differs from a true inhibitor in that the radical remains “stored” for use at a specific temperature whereas an inhibitor converts the radical into a permanently inactive species. The combination of a peroxide initiator and a nitroxide controller in accordance with the present invention allows the user to formulate resin compositions that exhibit long-term stability at room temperature, but retain very good reactivities at elevated temperatures. The unique nitroxides of the present invention disassociate at considerably lower temperatures than prior art nitroxide inhibitors. Thus, the unique nitroxides of the present invention provide for stability at room temperatures but disassociate at normal composite forming/molding temperatures allowing crosslinking control. Furthermore, the disclosed nitroxides also allow for the use of a wide variety of reactive monomer classes including styrenics, acrylics, acrylamides, dienes, vinylics and mixtures thereof as will be evident to those skilled in the art.

An example of the controlling capability of the nitroxide lies within the functionality within molding compounds made from the base resins. A key indicator of how well the molding compound will work is the gel-to-peak time, that is, the amount of time between the formation of initial gel and the development of peak exotherm temperature, which occurs at the end of the curing cycle. This property is important to molding compounds due to the fact that it governs how much time the compound has to completely fill the mold before gellation takes place. This reduces the chances of underfill in the mold. The nitroxide in this application delays the gel time without significantly delaying the overall cure time or temperature. The control aspect comes in the fact that by varying the amount of controller nitroxide used, the user can in effect manipulate how close together the gel time and peak exotherm time will occur. This demonstrates the true “controlling” capability of the nitroxide radical. This occurs from the fact that the nitroxide delays the onset of gelatin, but has a much less dramatic effect on the peak exotherm time and temperature. The reasoning for this effect is that the gel time is delayed due to the minimum energy of activation required to reach the equilibrium temperature of the nitroxide polymer pair, whereas at the peak exotherm, the equilibrium is already established and therefore only minimally affected by the nitroxide. Minimizing the effect on peak exotherm time and temperature is a key advantage as the production efficiency and energy costs are not affected.

The crosslinking control component of the present invention is a β-substituted stable free radical (nitroxide) type of the formula:

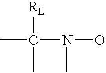

in which the R_{L} radical has a molar mass greater than 15. The monovalent R_{L} radical is said to be in the β position with respect to the nitrogen atom of the nitroxide radical. The remaining valencies of the carbon atom and of the nitrogen atom in the formula (1) can be bonded to various radicals such as a hydrogen atom or a hydrocarbon radical, such as an alkyl, aryl or aralkyl radical, comprising from 1 to 10 carbon atoms. The carbon atom and the nitrogen atom in the formula (1) may be connected to one another via a bivalent radical, so as to form a ring. However, the remaining valencies of the carbon atom and of the nitrogen atom of the formula (1) are preferably bonded to monovalent radicals. The R_{L} radical preferably has a molar mass greater than 30. The R_{L} radical can, for example, have a molar mass of between 40 and 450. The radical R_{L} can, by way of example, be a radical comprising a phosphoryl group, the R_{L} radical may be represented by the formula:

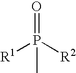

in which R¹ and R², which can be the same or different, can be chosen from alkyl, cycloalkyl, alkoxy, aryloxy, aryl, aralkyloxy, perfluoroalkyl and aralkyl radicals and can comprise from one to 20 carbon atoms. R¹ and/or R² can also be a halogen atom, such as a chlorine or bromine or fluorine or iodine atom. The R_{L} radical can also comprise at least one aromatic ring, such as the phenyl radical or the naphthyl radical, the latter may be substituted, for example by an alkyl radical comprising from one to four carbon atoms.

By way of example, the stable free radical can be chosen from: tert-butyl 1-phenyl-2-methylpropyl nitroxide; tert-butyl 1-(2-naphthyl)-2-methylpropyl nitroxide; tert-butyl 1-diethylphosphono-2,2-dimethylpropyl nitroxide; tert-butyl 1-dibenzylphosphono-2,2-dimethylpropyl nitroxide; phenyl 1-diethylphosphono-2,2-dimethylpropyl nitroxide; phenyl 1-diethylphosphono-1-methylethyl nitroxide; 1-phenyl-2-methylpropyl 1-diethylphosphono-1-methylethyl nitroxide.

A preferred β-substituted nitroxide is a β-phosphorous of the formula:

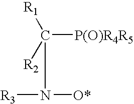

in which R₁ and R₂, which are identical or different, represent a hydrogen atom, a linear, branched or cyclic alkyl radical having a number of carbon atoms ranging from 1 to 10, an aryl radical, or an aralkyl radical having a number of carbon atoms ranging from 1 to 10, or else R₁ and R₂ are connected to one another so as to form a ring which includes the carbon atom carrying said R₁ and R₂ said ring having a number of carbon atoms, including the carbon carrying the R₁ and R₂ radicals, ranging from 3 to 8; R₃ represents a linear or branched and saturated or unsaturated hydrocarbonaceous radical which can comprise at least one ring, said radical having a number of carbon atoms ranging from 1 to 30; and R₄ and R₅, which are identical or different, represent a linear or branched alkyl radical having a number of carbon atoms ranging from 1 to 20 or a cycloalkyl, aryl, alkoxyl, aryloxyl, aralkyloxyl, perfluoroalkyl, aralkyl, dialkyl- or diarylamino, alkylaryl amino or thioalkyl radical, or else R₄ and R₅ are connected to one another so as to form a ring which includes the phosphorus atom, said heterocycle having a number of carbon atoms ranging from 2 to 4 and being able in addition to comprise one or more oxygen, sulfur or nitrogen atoms. Methods of preparing this class of preferred β-phosphorous nitroxides are disclosed in U.S. Pat. No. 6,624,322 and U.S. Pat. No. 6,255,448.

The stable free radical crosslinking control component of the present invention may also comprise β-substituted alkoxyamines. The β-substituted alkoxyamines are exemplified by formula (I) wherein A represents a mono- or polyvalent structure and R_{L} represents a mole weight of more than 15 and is a monovalent radical, and n≧1.

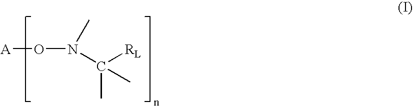

Multifunctional alkoxyamines of formula (I), wherein n≧2, may be utilized. The nitroxides may comprise several alkoxyamines comprising the sequence of formula (I), wherein n is a non-zero integer and the alkoxyamines exhibit different values of n. The alkoxyamines and nitroxyls (which nitroxyls may also be prepared by known methods separately from the corresponding alkoxyamine) as described above are well known in the art. Their synthesis is described for example in U.S. Pat. No. 6,255,448 and U.S. Pat. No. 6,624,322. The polyalkoxyamines of formula (I) may be prepared according to methods known in the literature. The method most commonly used involves the coupling of a carbon-based radical with a nitroxide radical. The coupling may be performed using a halo derivative A(X)ₙ in the presence of an organometallic system, for instance CuX/ligand (X=Cl or Br) according to a reaction of ATRA (Atom Transfer Radical Addition) type as described by D. Greszta et al. in Macromolecules 1996, 29, 7661-7670. A preferred ligand is —N,N,N′,N′,N″-pentamethyldiethylenetriamine (PMDETA):

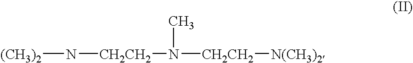

Their synthesis is described for example in US Patent Publication 2006/142511.

A preferred alkoxyamine is one which produces the N-tert-butyl-N-[1-diethylphosphono-(2,2-dimethylpropyl)]nitroxide (DEPN) radical upon dissociation. One particularly effective class of nitroxide sources includes compounds such as iBA-DEPN, shown below, where the DEPN radical is linked to an isobutyric acid radical or an ester or amide thereof. If esters or amides are used, they are preferably derived from lower alkyl alcohols or amines, respectively.

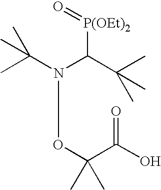

The combination of a peroxide initiator system and a nitroxide controller of the present invention allows the user to formulate resin compositions that exhibit long stability at room temperature but very good reactivities at elevated temperatures. The nitroxides of the present invention disassociate at temperatures significantly lower than prior art nitroxides such as TEMPO. A further advantage over the TEMPO nitroxides, is the ability of the disclosed nitroxides to allow for the use of a wide variety of reactive monomer classes including styrenics, acrylates, acrylamides, dienes, vinylinics and mixtures thereof as will be evident top those skilled in the art. Thus, the nitroxides of the present invention disassociate and do not serve as crosslinking inhibitors at the typical temperatures of processing/molding of composite resins yet provide crosslinking control at room temperatures to enhance resin potlife etc.

The nitroxide crosslinking controller can be added to the peroxide initiator system prior to or at the time of addition to the composite resin. The nitroxide itself can be added directly to one of the peroxide initiators as a “package”. This is possible due to the unique property of nitroxides that they are inactive to oxygen radicals, but active to carbon radicals. This blend can then be added to the resin and mixed as a normal peroxide initiator would be incorporated into the resin system. The nitroxide can be added to the resin solution separately as well, providing greater polyester resin storage life without having a negative impact on the crosslinking time or temperatureand further lending flexibility to the resin formulator. The combination of peroxide and initiator could also be used as a one part initiator that contains both initiating and controlling features in one package.

The conversion of the crosslinkable compositions into molded or extruded articles may be carried out during or after crosslinking.

### EXAMPLES

### Example 1

In the first example, a pultrusion bath resin is formulated in the following manner:

| | |
|---|---|
| Isophthalic polyester resin | 61.50 lbs. |
| Peroxide | 0.615 lbs. |
| (blend of: di (2-ethylhexyl) peroxydicarbonate | |
| (Luperox 223 V75*) t-amyl peroxy 2-ethylhexanoate | |
| (Luperox 575*) OO-(t-amyl) O (2-ethylhexyl) | |
| monoperoxycarbonate (Luperox MC*) | |
| ratio about .3/.4/.3) | |
| stearate ester | 0.460 lbs. |
| Calcium Carbonate | 12.10 lbs. |
| Nitroxide | 0.031 lbs. |
| (tert-butyl 1-diethylphosphono-2,2-dimethylpropyl nitroxide) | |
| Total | 75.0 lbs. |

*Available from Arkema Inc., Philadelphia, PA

The materials are added using a cowles blender, with all other additives including the radical controller being added and sheared in until homogenous before adding the peroxides in last. The resin can then be transferred to a pultrusion resin bath and used as normal, with a much longer usable resin life expected.

As an alternative, the controller could be pre-blended into the resin, or into one of the constituent peroxides to make addition of such small quantities easier. The controller could also be added in a diluted form in plasticizer to increase the accuracy of addition.

### Example 2

In an SMC formulation, the molding compound is blended as follows:

| | | |
|---|---|---|
| UPR resin | 60 | lbs. |
| polyvinyl acetate | 40 | lbs. |
| CaCo₃ Filler | 150 | lbs. |
| Zinc stearate | 4 | lbs. |
| Magnesium Oxide paste | 2 | lbs. |
| Peroxide | 1.5 | lbs. |
| (OO-(t-amyl) O (2-ethylhexyl) monoperoxycarbonate | | |
| (Luperox MC*)) | | |
| Nitroxide | 8-32 | grams |
| (tert-butyl 1-diethylphosphono-2,2-dimethylpropyl | | |
| nitroxide) | | |
| Chopped Glass | 85.8 | lbs. |

*Available from Arkema Inc., Philadelphia, PA

The SMC resin paste is mixed (minus the glass) and poured into the resin troughs of the SMC machine. The paste is then distributed onto film and glass added and mixed in by compression rollers with the subsequent molding compound rolled onto a mandrel and aged to proper viscosity. When the molding compound is used, the mold fill should be affected as more controller is used.

1. A thermosetting resin polymerization initiating system comprising:
a radical initiator free radical polymerization initiator; and
a β substituted nitroxide polymerization control agent.

2. The thermosetting resin polymerization initiating system of claim 1 wherein said radical initiator free radical is selected from the group consisting of diacyl peroxides, peroxydicarbonates and peroxyesters.

3. The thermosetting resin polymerization initiating system of claim 2, wherein said peroxydicarbonate is selected from the group consisting of diethyl peroxydicarbonate, di-n-butyl peroxydicarbonate, diisobutyl peroxydicarbonate, and di-4-tert-butylcyclohexyl peroxydicarbonate. Preferably the peroxydicarbonate is di-sec-butyl peroxydicarbonate, di-2-ethylhexyl peroxydicarbonate, di-n-propyl peroxydicarbonate and diisopropyl peroxydicarbonate.

4. The thermosetting resin polymerization initiating system of claim 2, wherein said diacyl peroxide is selected from the group consisting of benzoyl peroxide, dilauroyl peroxide, didecanoyl peroxide, diacetyl peroxide and di(3,5,5-trimethylhexanoyl) peroxide.

5. The thermosetting resin polymerization initiating system of claim 2, wherein said peroxyester is selected from the group consisting of t-butyl perneodecanoate, t-butyl and t-amyl peroxy 2-ethylhexanoate, and t-butyl perbenzoate. In addition the monoperoxycarbonates based on t-butyl and t-amyl monoperoxy 2-ethylhexyl carbonates.

6. The thermosetting resin polymerization initiating system of claim 1 wherein said β substituted nitroxide polymerization control agent is of formula 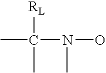
in which the R_{L} radical has a molar mass greater than 15.

7. The thermosetting resin polymerization initiating system of claim 6 wherein R_{L} comprises a phosphoryl group.

8. The thermosetting resin polymerization initiating system of claim 7 wherein R_{L} is represented by the formula 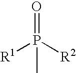
in which R¹ and R² can be identical or different, and selected from the group consisting of halogens, or alkyl, cycloalkyl, alkoxy, aryloxy, aryl, aralkyloxy, perfluoroalkyl or aralkyl radicals.

9. The thermosetting resin polymerization initiating system of claim 6 wherein R_{L} comprises at least one aromatic ring.

10. The thermosetting resin polymerization initiating system of claim 1 wherein the β substituted nitroxidc polymerization control agent is selected from the group consisting of tert-butyl 1-diethylphosphono-2,2-dimethylpropyl nitroxide and tert-butyl 1-phenyl-2-methylpropyl nitroxide.

11. A thermosetting resin combination comprising:
a resin;
a radical initiator free radical polymerization initiator; and
a β substituted nitroxide polymerization control agent.

12. The thermosetting resin combination of claim 11 wherein said resin is selected from the group consisting of unsaturated polyester resins, vinyl ester resins, dicyclopentadiene resins and mixtures thereof.

13. The thermosetting resin combination of claim 11 wherein said organic peroxide free radical is selected from the group consisting of diacyl peroxides, peroxydicarbonates and peroxyesters.

14. The thermosetting resin combination of claim 13, wherein said peroxydicarbonate is selected from the group consisting of diethyl peroxydicarbonate, di-n-butyl peroxydicarbonate, di-sec-butyl peroxydicarbonate, diisobutyl peroxydicarbonate, di-2-ethylhexyl peroxydicarbonate, di-n-propyl peroxydicarbonate, diisopropyl peroxydicarbonate and di-4-tert-butylcyclohexyl peroxydicarbonate.

15. The thermosetting resin combination of claim 13, wherein said diacyl peroxide is selected from the group consisting of benzoyl peroxide, dilauroyl peroxide, didecanoyl peroxide, diacetyl peroxide and di(3,5,5-trimethylhexanoyl)peroxide.

16. The thermosetting resin combination of claim 13, wherein said peroxyester is selected from the group consisting of t-butyl perneodecanoate, t-butyl and t-amyl peroxy 2-ethylhexanoate, and t-butyl perbenzoate.

17. The thermosetting resin combination of claim 11 wherein said β substituted nitroxide polymerization control agent is of formula 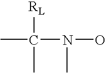
in which the R_{L} radical has a molar mass greater than 15.

18. The thermosetting resin combination of claim 17 wherein R_{L} comprises a phosphoryl group.

19. The thermosetting resin combination of claim 18 wherein R_{L} is represented by the formula 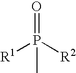
in which R¹ and R² can be identical or different, and selected from the group consisting of halogens, or alkyl, cycloalkyl, alkoxy, aryloxy, aryl, aralkyloxy, perfluoroalkyl or aralkyl radicals.

20. The thermosetting resin combination of claim 17 wherein R_{L} comprises at least one aromatic ring.

21. The thermosetting resin combination of claim 11 wherein the β substituted nitroxide polymerization control agent is selected from the group consisting of tert-butyl 1-diethylphosphono-2,2-dimethylpropyl nitroxide and tert-butyl 1-phenyl-2-methylpropyl nitroxide.

22. A thermosetting resin combination comprising:
a resin;
a β substituted nitroxide polymerization control agent; and
a reactive diluent.

23. The thermosetting resin combination of claim 23 wherein said reactive diluent is styrene.

24. The thermosetting resin polymerization initiating system of claim 1 wherein said β substituted nitroxide polymerization control agent is of formula 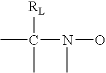
in which the R_{L} radical has a molar mass greater than 15.

25. The thermosetting resin combination of claim 22 wherein the β substituted nitroxide polymerization control agent is selected from the group consisting of tert-butyl 1-diethylphosphono-2,2-dimethylpropyl nitroxide and tert-butyl 1-phenyl-2-methylpropyl nitroxide.

26. A method of controlling the polymerization of a thermosetting resin and radical initiator free radical polymerization initiator combination comprising adding to said combination a polymerization controlling amount of a β substituted nitroxide polymerization control agent.

27. The method of claim 26 wherein said radical initator free radical is selected from the group consisting of diacyl peroxides, peroxydicarbonates and peroxyesters.

28. The method of claim 27, wherein said peroxydicarbonate is selected from the group consisting of diethyl peroxydicarbonate, di-n-butyl peroxydicarbonate, di-sec-butyl peroxydicarbonate, diisobutyl peroxydicarbonate, di-2-ethylhexyl peroxydicarbonate, di-n-propyl peroxydicarbonate, diisopropyl peroxydicarbonate and di-4-tert-butylcyclohexyl peroxydicarbonate.

29. The method of claim 27, wherein said diacyl peroxide is selected from the group consisting of benzoyl peroxide, dilauroyl peroxide, didecanoyl peroxide, diacetyl peroxide and di(3,5,5-trimethylhexanoyl)peroxide.

30. The method of claim 27, wherein said peroxyester is selected from the group consisting of t-butyl perneodecanoate, t-butyl peroxy 2-ethylhexanoate, OO-(t-butyl) O-(2-ethylhexyl)monoperoxycarbonate, t-amyl peroxy 2-ethylhexanoate, OO-(t-amyl)O-(2-ethylhexyl)monoperoxycarbonate, and t-butyl perbenzoate.

31. The method of claim 26 wherein said β substituted nitroxide polymerization control agent is of formula 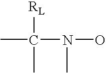
in which the R_{L} radical has a molar mass greater than 15.

32. The method of claim 31 wherein R_{L} comprises a phosphoryl group.

33. The method of claim 32 wherein R_{L} is represented by the formula 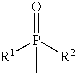
in which R¹ and R² can be identical or different, and selected from the group consisting of halogens, or alkyl, cycloalkyl, alkoxy, aryloxy, aryl, aralkyloxy, perfluoroalkyl or aralkyl radicals.

34. The method of claim 31 wherein R_{L} comprises at least one aromatic ring.

35. The method of claim 26 wherein the β substituted nitroxide polymerization control agent is selected from the group consisting of tert-butyl 1-diethylphosphono-2,2-dimethylpropyl nitroxide and tert-butyl 1-phenyl-2-methylpropyl nitroxide.
